(19) United States
(12) Patent Application Publication
(10) Pub. No.: US 2001/0022435 A1
(43) Pub. Date: Sep. 20, 2001

(54) Flexible snowmobile ski runner

(76) Inventor: Dale DeWayne Cormican, Mentor, MN (US)

Correspondence Address: Michael S. Neustel, 2534 South Universty Drive, Suite No. 4, Fargo, ND, 58103, US

(21) Appl. No.: 09/792,074

(22) Filed: Feb. 22, 2001

Related U.S. Application Data
(63) Continuation-in-part of application No. 09/338,079, filed on Jun. 23, 1999, now abandoned.

(51) Int. Cl. B62B 9/04

(52) U.S. Cl. 280/28; 280/845

(57) ABSTRACT

A mechanism that improves the steering characteristics of molded plastic skis is provided that employs the use of a flexible carbide steering cleat. This flexible carbide steering cleat is made up of a plurality of carbide tipped steering members that are attached individually to the lower surface of a plastic one piece snowmobile ski. Each of the individual cleat members is equipped with a mounting plate that has indentations on either side which, when a series of the cleats have been placed in the keel in succession, creates a space between them. This space allows the cleat members to flex independently of one another in response to the flexing of the ski without binding on one another. Therefore, the flexing ability of the present invention allows the individual cleat members to maintain the maximum contact with the snow surface, regardless of how much the ski itself flexes during its use.

This application is a continuation-in-part of U.S. patent application Ser. No. 09/338,079 filed Jun. 23, 1999.

### BACKGROUND OF THE INVENTION

The present invention relates to an improvement in skis used on snowmobiles or other vehicles to facilitate forward movement and steering. More specifically, to a flexible ski cleat which will allow a flexible ski constructed from Ultra High Molecular Weight Polyethylene (UHMW) or similar materials to flex and bend without inhibition.

Typical snowmobiles are powered by a front mounted engine attached to a rear endless track system. The track on conventional snowmobiles is suspended using springs and gas powered shocks to absorb the bumps and aid in control and handling of the snowmobile. These snowmobiles are typically supplied with two skis attached to a rider operated steering system. The skis are placed in front of the track system and are, thus, the first part of the vehicle to meet obstacles such as rocks, logs or bumps. Different manufacturers have developed and utilized several different means of adding travel to each individual ski system. These systems range from a wishbone type suspension to an upright spring and dampener type system.

The classic, or conventional, snowmobile ski is constructed of metal and attaches to the steering system mechanism at a point near the middle of the ski. These skis will typically be supplied with one or more long, rigid, runners on the under surface of the ski. These runners will often utilize carbide insets of varying degrees. The runners and insets may be of varying degrees of aggressiveness, using different amounts and styles of carbide, depending upon a users particular needs.

The metal ski and rigid runner has been standard for many years, but recently the industry has begun adopting skis made of metal bridges, reinforcements, plastic portions and solid plastic skis. This plastic may be of a type such as a Ultra High Molecular Weight Polyethylene (UHMW or UHMW-PE) plastic. This type of ski has been developed to overcome some of the disadvantages of the metal ski. One of these disadvantages has been that metal skis are unyielding and thus, subject to dents and bends as the ski is used in normal operation. These bends and dents eventually lead to a drop in performance of the ski and often necessitate the replacement of the ski. The use of flexible and resilient plastics has resulted in skis that are durable and able to withstand impacts that would have damaged conventional metal skis. One inherent problem with the flexible skis is the inability to use current rigid runners on the bottom of the ski without affecting the skis ability to flex.

A second problem with all current rigid runners is that it may be difficult or time consuming to change the runners when necessary. Currently, many state parks have enacted laws which prohibit the use of carbide runners within their boundaries in order to protect the park trails. This has required riders to remove the ski runners before entering the park. Further, more aggressive riders may wish to change or switch between different types of ski runners frequently so as to reach optimal performance for any given condition.

From this discussion it can be seen that it is desirable to supply a flexible carbide runner that may be used with flexible skis that work to absorb bumps during riding. It is also desirable to make this flexible carbide easy to remove and change to different styles, as required or desired by the given rider. Further, it is necessary that this flexible runner be designed to flex evenly throughout its length so that it will not hinder the ski's ability to flex.

### SUMMARY OF THE INVENTION

It is the primary objective of the present invention to provide a steering cleat mechanism for flexible plastic snowmobile skis.

It is an additional objective of the present invention to provide such a steering mechanism that employs a carbide tipped steering cleat.

It is still a further objective of the present invention to provide such a carbide tipped steering cleat that can flex along with the flexible plastic ski.

These objectives are accomplished by the use of a flexible carbide steering cleat that is made up of a plurality of carbide tipped steering members that are attached individually, with a slight spacing to allow for flexing, to the lower surface of the 90 degree keel of a UHMW plastic one piece snowmobile ski. This attachment is facilitated by the use of a plurality of roll pins or other fasteners that are inserted into holes in the side of the ski keel and then through corresponding holes located on the mount plates of the individual cleat members and out the other side of the keel where they are secured. The individual mounting of the cleat members allows their numbers to be varied to suit local conditions or operator preferences.

Each of the individual cleat members is equipped with a mounting plate that has indentations on either side which, when a series of the cleats have been placed in the keel in succession, creates a space between them. This space allows the cleat members to flex independently of one another in response to the flexing of the ski, without binding on one another. Therefore, the flexing ability of the present invention allows the individual cleat members to maintain the maximum contact with the snow surface, regardless of how much the ski itself flexes during its use.

For a better understanding of the present invention reference should be made to the drawings and the description in which there are illustrated and described preferred embodiments of the present invention.

### DESCRIPTION OF THE DRAWINGS

FIG. 1 is a perspective view of a one piece molded ski showing the manner in which its major components relate to one another.

FIG. 2 is a top elevation view of a one piece molded ski showing the orientation of its major components in relation to the body of the ski.

FIG. 3 is a side elevation view of a one piece molded ski showing the orientation of its major components in relation to the body of the ski.

FIG. 4 is a bottom elevation view of a one piece molded ski showing the location of the 90 degree keel and the location of the present invention within it.

FIG. 5 is a front elevation cut-away view of a one piece molded ski showing the location of the present invention within the 90 degree keel.

FIG. 6 is a side elevation exploded view of the present invention showing the method by which the individual pieces which comprise the invention fit within the 90 degree keel of the one piece molded ski.

FIG. 7 is a side elevation view of the central portion of a one piece molded ski showing the location and spacing of the present invention along the 90 degree keel.

FIG. 8 is a bottom elevation view of the central portion of a one piece molded ski showing the location of an embodiment of the present invention within the lower surface of the 90 degree keel.

FIG. 9 is an exploded side elevation view of the central portion of a one piece molded ski showing the manner in which the components of the invention are connected to and held within the 90 degree keel of the ski.

FIG. 10 is a front elevation cut-away view of the present invention showing the manner in which the present invention fits into and is held within the 90 degree keel of the one piece molded ski.

FIG. 11 is a side elevation view of the present invention showing its manner of construction and the orientation of its major components.

FIG. 12 is a front elevation view of the present invention showing its manner of construction and the orientation of its major components.

FIG. 13 is a side elevation view of an alternative embodiment of the present invention in which the mounting plate is made up of two separate components which are sandwiched together to form the carbide mount tabs.

FIG. 14 is a front elevation view of an alternative embodiment of the present invention in which the mounting plate is made up of two separate components which are sandwiched together to form the carbide mount tabs.

FIG. 15 is a side elevation view of an additional alternative embodiment of the present invention in which the steering cleat is made of a single flexible piece of UHMW plastic.

FIG. 16 is a front elevation view of an additional alternative embodiment of the present invention in which the steering cleat is made of a single flexible piece of UHMW plastic.

FIG. 17 is a front elevation cut-away view of an alternative embodiment of the present invention showing the manner in which a flat-bottomed cleat fits into and is held within the 90 degree keel of a standard one piece molded snowmobile ski.

FIG. 18 is a side elevation view of the alternative embodiment of the present invention as illustrated in FIG. 17 and which shows both the flat sided nature of this embodiment of the invention and the orientation of an individual installed cleat in relation to its neighbor.

FIG. 19 is a front elevation view of the alternative embodiment of the present invention as illustrated in FIG. 17 and which shows the general configuration of the flat-bottomed cleat as opposed to that of earlier embodiments.

FIG. 20 is a front elevation cut-away view of a still further alternative embodiment of the present invention showing the manner in which a flat-bottomed cleat is provided which is formed entirely as one piece of austempered ductile iron (herein after referred to as ADI).

FIG. 21 is a side elevation view of the further alternative embodiment of the present invention as illustrated in FIG. 20 and which shows both the flat sided nature of this embodiment of the invention and the orientation of an individual installed cleat in relation to its neighbor.

FIG. 22 is a front elevation view of the further alternative embodiment of the present invention as illustrated in FIG. 20 and which shows the general configuration of a ADI molded flat-bottomed cleat as opposed to that of the previously described embodiments.

### DESCRIPTION OF THE PREFERRED EMBODIMENT

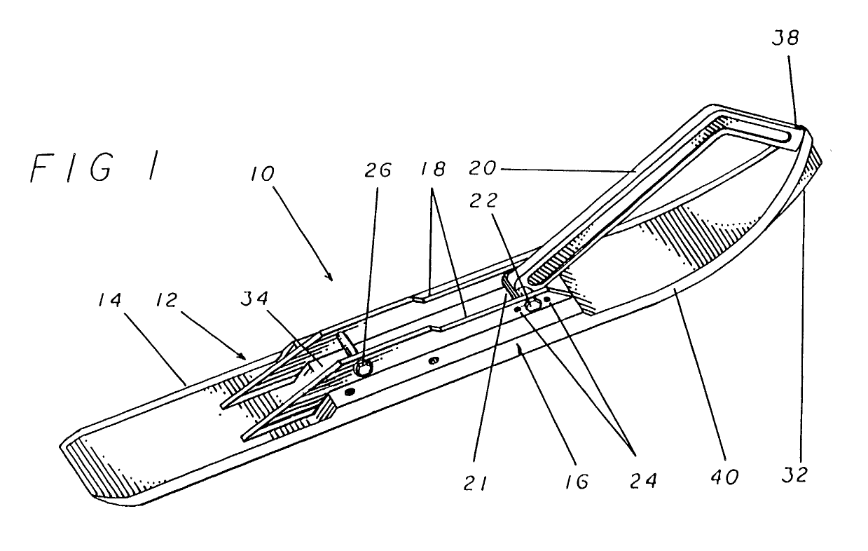

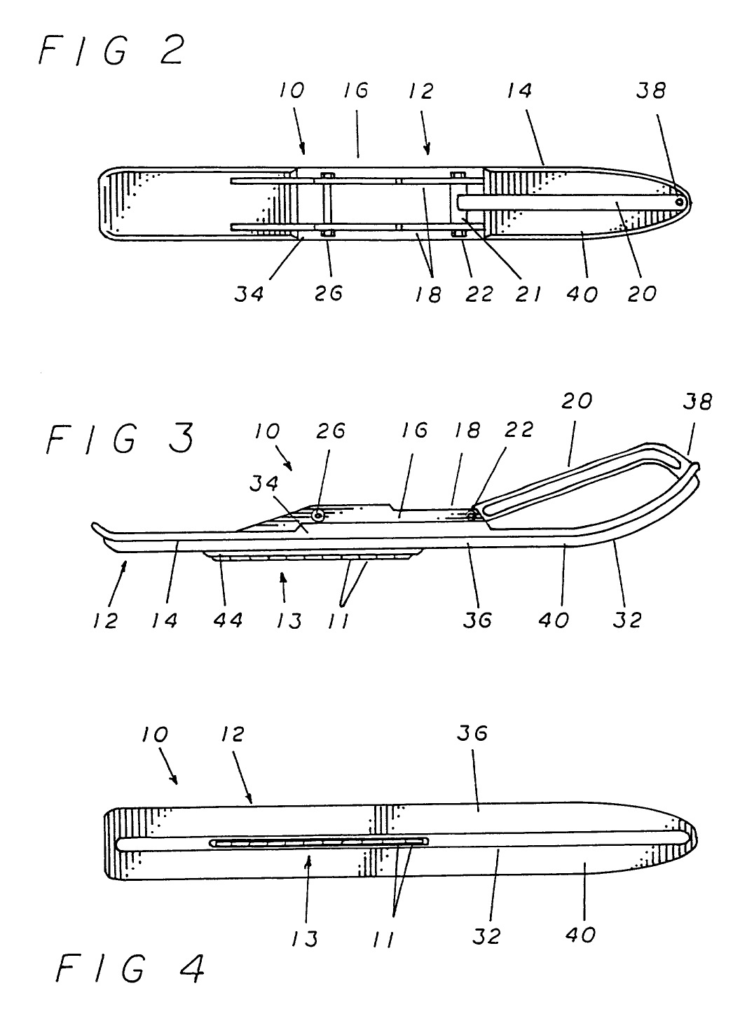

Referring now to the drawings, and more specifically to FIGS. 1, 2, 3 and 4, the one piece molded snowmobile ski 10 is made up of a ski body 12 which provides the base to which the other components are attached. The ski body 12 has ridges running laterally along the entire upper lengths and extending upwards therefrom the ski edges 14 which form a shallow depression in the center of the upper surface of the ski body 12. At the longitudinal center of the ski body 12, this depression is filled in and raised above the upper most surface of the ski edges 14 to form the saddle mounting platform 34. On the upper surface of the saddle mounting platform 34, two projections called the saddle vertical mount plates 18 extend upward and form the attachment point for the ski mount bolt 26 which facilitates the attachment of the present invention to a snowmobile.

The ski body 12, the saddle mounting platform 34 and the one-piece ski saddle 16 are all formed from one piece of UHMW plastic in a manner so that the natural state of the present invention is flat along the entire length in regards to the upper surface of the ski body 12. This one piece construction provides a lightweight ski that is extremely strong and that is less expensive to produce, and therefore sell more than multiple piece snowmobile ski designs.

The pre-load function of the present invention is provided by bending the forward most portion of the ski body 12 at the ski pre-load zone 40, which narrows down to a point at its front tip as in a standard ski, in an upward fashion. It is then held in this position by the use of the pre-load bar 20 which extends forward from the front of the one-piece ski saddle 16 to the tip of the ski body 12. At reward end, the pre-load bar 20 is attached to the saddle vertical mount plates 18 of the one piece ski saddle 16 by the use of the pre-load rear mount 21, which is a perpendicularly mounted cylindrical portion of the pre-load bar 20 having a hole bored longitudinally though its center. The forward most end of the pre-load bar 20, is attached to the front of the ski body 12 by the use of the pre-load bar front mount 38.

The attachment of the pre-load bar 20 forces the ski tip to be held in an upwardly curved position.

The variable pre-load bar mount holes 24 located on the front portion of the saddle vertical mount plates 18 provide a means of varying the amount of pre-load placed on the ski body 12. The pre-load bar 20 is pivotally attached to the one-piece ski saddle 16 by passing the pre-load rear mount bolt 22 through one of the variable pre-load bar mount holes 24, through the pre-load rear mount 21 and out the opposite variable pre-load mount hole 24 where it is held in place by the use of a nut which threads onto its most outward end.

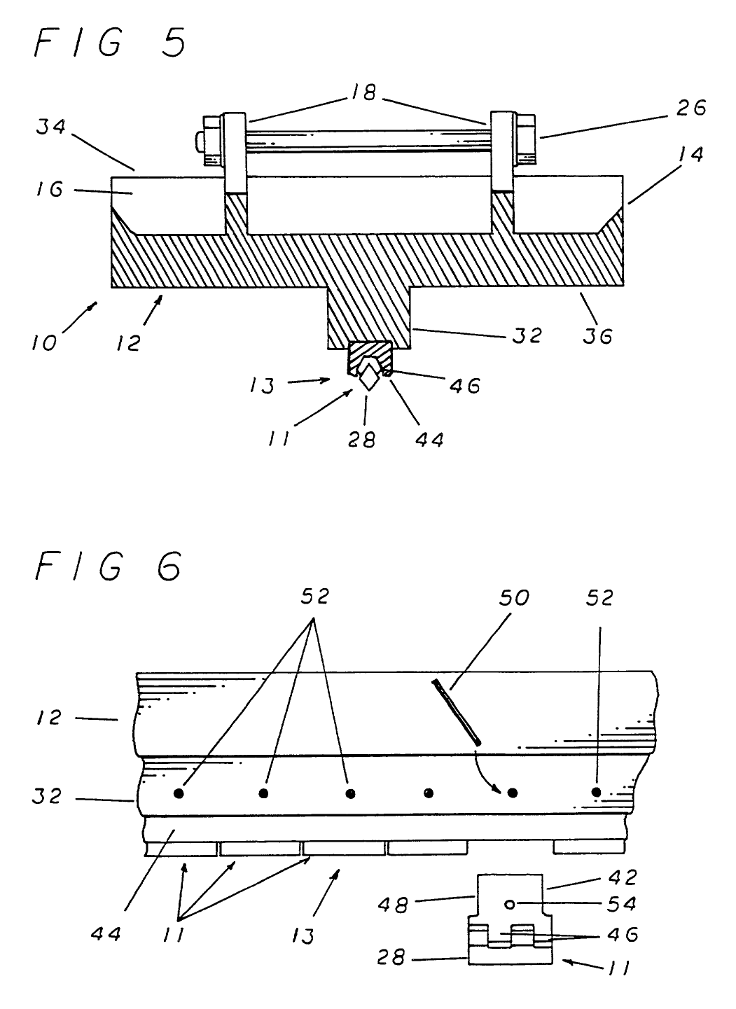

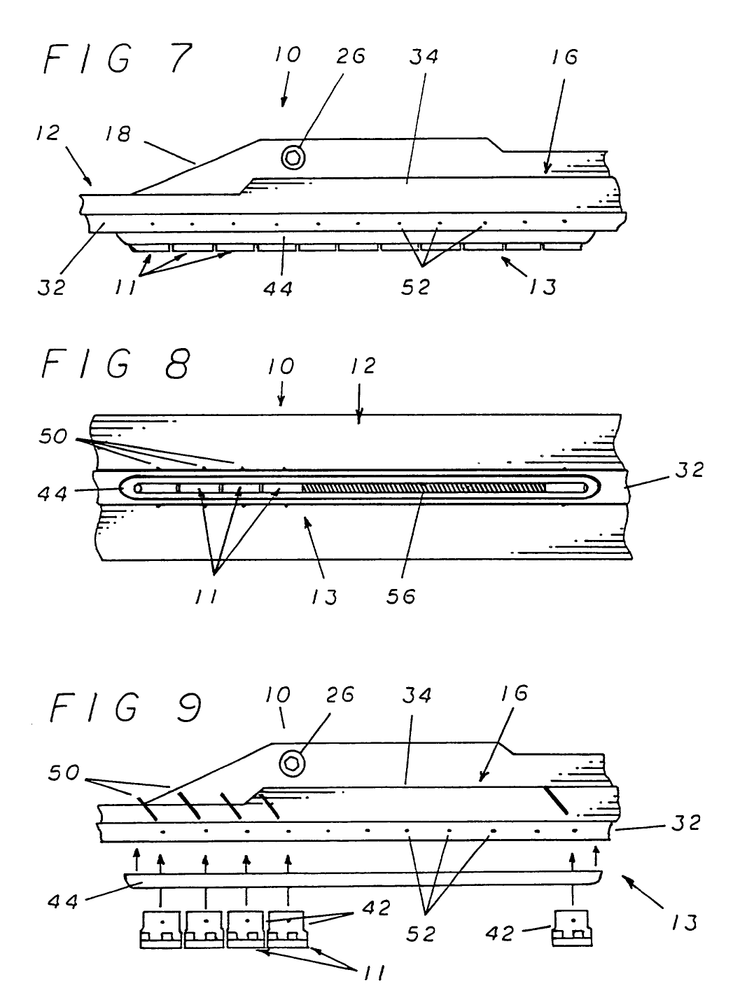

The flexible steering cleat 13 is used in conjunction with a one piece molded snowmobile ski 10, or other similar apparatus employed to provide steering imputes on snow, and its orientation with respect to the one piece molded ski 10 is illustrated in FIGS. 5 and 7. The flexible steering cleat 13 is attached to the lower most surface of the 90 degree keel 32 which is a square shaped protrusion that runs along the center of the flat ski bottom 36 for the entire length of the ski body 12. The present invention is used to enhance the steering characteristics of the 90 degree keel 32 by providing it with a sharp extending edge that imbeds into and engages the surface of the snow.

The present invention fits into the 90 degree keel 32 at approximately its center point (in relation to the front and rear ends of the one piece molded snowmobile ski 10) in a manner in which it runs both forward and rearward of the point at which the one piece molded ski 10 is attached to a snowmobile at the ski mount bolt 26. In this position, the present invention is located on the portion of the one piece molded snowmobile ski 10 that bears the majority of the weight which is transferred to the one piece molded snowmobile ski 10 from the snowmobile. This ensures that the present invention will operate effectively to enhance the steering impetus provided by the one piece molded snowmobile ski 10 to the snowmobile.

The configuration of the major components of the present invention is illustrated in FIGS. 11 and 12. The flexible steering cleat 13 is primarily made up of a plurality of individual steering cleat members 11, appropriately spaced to allow flexing of the one piece molded snowmobile ski 10, the individual steering cleat members 11 are independently anchored to the 90 degree keel 32 of the one piece molded snowmobile ski 10. These steering cleat members 11 are composed of a carbide mount plate 48 which is a flat rectangular metallic tab that provides the mounting point for the individual steering cleat members 11 and contains a plate pin hole 54 at its center for that purpose. Additionally, both outside edges of the carbide mount plates 48 are slightly indented towards the center of the carbide mount plate 48. The important factor of this design feature is that when the individual steering cleat members 11 are placed in the 90 degree keel 32 to form the flexible steering cleat 13 the flex indentations 42 create gaps between the steering cleat members 11. This allows the steering cleat members 11 to flex independently to compensate for varying degrees of flexing within the one piece molded snowmobile ski 10. The individual steering cleats 11 each generally contain a carbide cleat 28 which may be an elongate rectangular or similarly shaped piece of carbide.

The lower end of the carbide mount plate 48 is vertically cut to form a plurality of carbide mount tabs 46, half of which are bent outward in one direction and the other half are bent outward in the other direction. This forms a Y-type configuration at the lowest most point of the carbide mount plate 48 between these carbide mount tabs 46 into which the carbide cleat 28, is inserted and permanently attached. The carbide cleat 28 is the component of the present invention that provides the increase of steering impetus to the one piece molded snowmobile ski 10 and this configuration supplies the solid mounting for the carbide cleat 28 within the steering cleat members 11 that is necessary to provide the desired steering impetus to the one piece molded snowmobile ski 10.

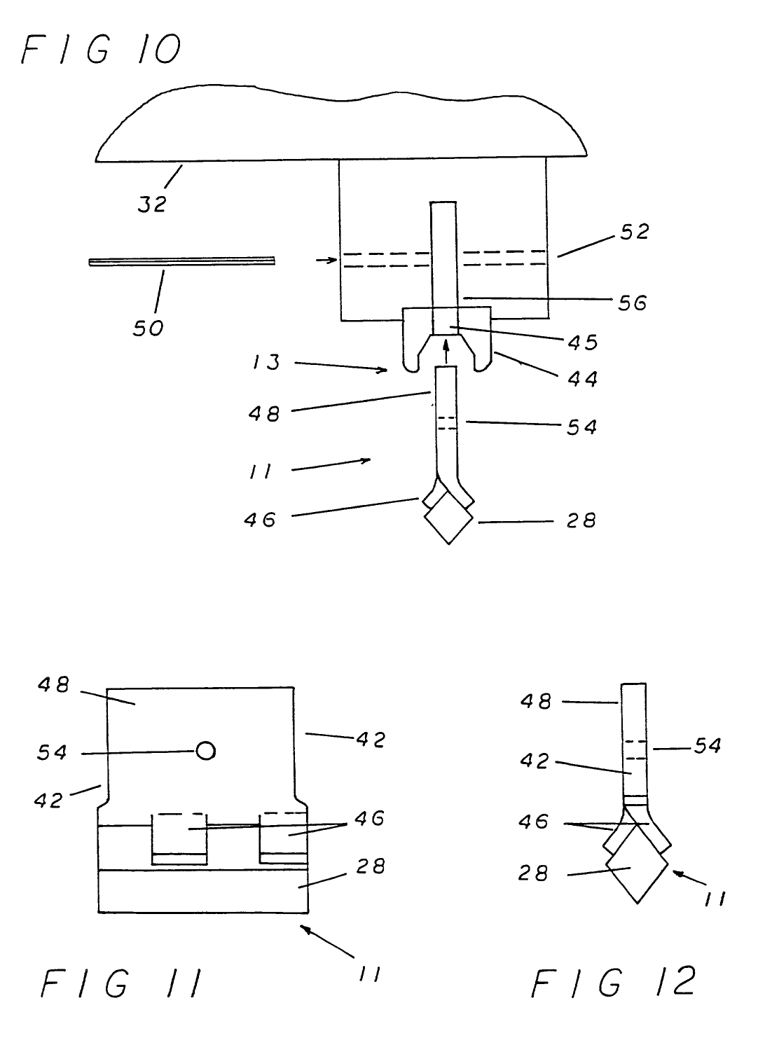

The specific manner in which the individual steering cleat members 11 fit within, and are attached to, the 90 degree keel 32 is illustrated in FIGS. 6, 9 and 10. The 90 degree keel 32 is equipped with a keel mount slot 56 which is a slot that is cut into the 90 degree keel 32 from its bottom surface upwards. The 90 degree keel 32 is also equipped with a plurality of keel pin holes 52 which pass laterally through it and the keel mount slot 56 from one side of the 90 degree keel 32 to the other.

Additionally, these keel pin holes 52 are spaced so that their position corresponds with the position of the plate pin hole 54 located in the carbide mount plate 48 when the steering cleat members 11 are placed in the keel mount slot 56. This positioning allows a roll pin 50 or other appropriate fastener to be passed through the keel pin hole 52 and the plate pin hole 54 once the steering cleat members 11 have been inserted into the keel mount slot 56. The roll pins 50 not only hold the steering cleat members 11 securely within the keel mount slot 56, but can be easily removed to allow for easy removal and replacement of the steering cleat members 11.

The present invention is also equipped with a flexible cleat housing 44 which fits between the 90 degree keel 32 and the steering cleat members 11. The flexible cleat housing 44 is made of a single piece of UHMW plastic that is a U-shaped channel which has an open housing slot 45 in its closed end which is smaller in size than the end and corresponds in size and location to the opening of the keel mount slot 56. Prior to placing the steering cleat members 11 into the keel mount slot 56, the flexible cleat housing 44 is placed on the 90 degree keel 32 with the housing slot 45 positioned over the keel mount slot 56. After this is done, the carbide mount plate 48 of the steering cleat members 11 are passed through the housing slot 45 and into the keel mount slot 56 to the point at which the plate pin holes 54 line up with the keel pin holes 52. This allows the roll pins 50 to pass through the 90 degree keel 32 and the steering cleat members 11 to hold the latter firmly in place.

The flexible cleat housing 44 is held in place on the 90 degree keel 32 due to the fact that the opening of the housing slot 45 is narrower than the width of the carbide mount tab 46 portion of the steering cleat members 11. Therefore, when the steering cleat members 11 are held in place within the 90 degree keel 32, the flexible cleat housing 44 is pinched between the carbide mount tabs 46 and the 90 degree keel 32 which secures it in the desired location. Additionally, it is important to note that the carbide cleats 28 extend beyond the outer limits of the open ends of the flexible cleat housing 44. This allows the carbide cleats 28 located on the outer most portion of the steering cleat members 11 to engage the snow while the flexible cleat housing 44 directs the flow of snow over the carbide cleats 28. The flexible cleat housing 44 also keeps the snow from engaging the remaining portions of the steering cleat members 11 which would create unnecessary drag on the snowmobile one piece molded snowmobile ski 10.

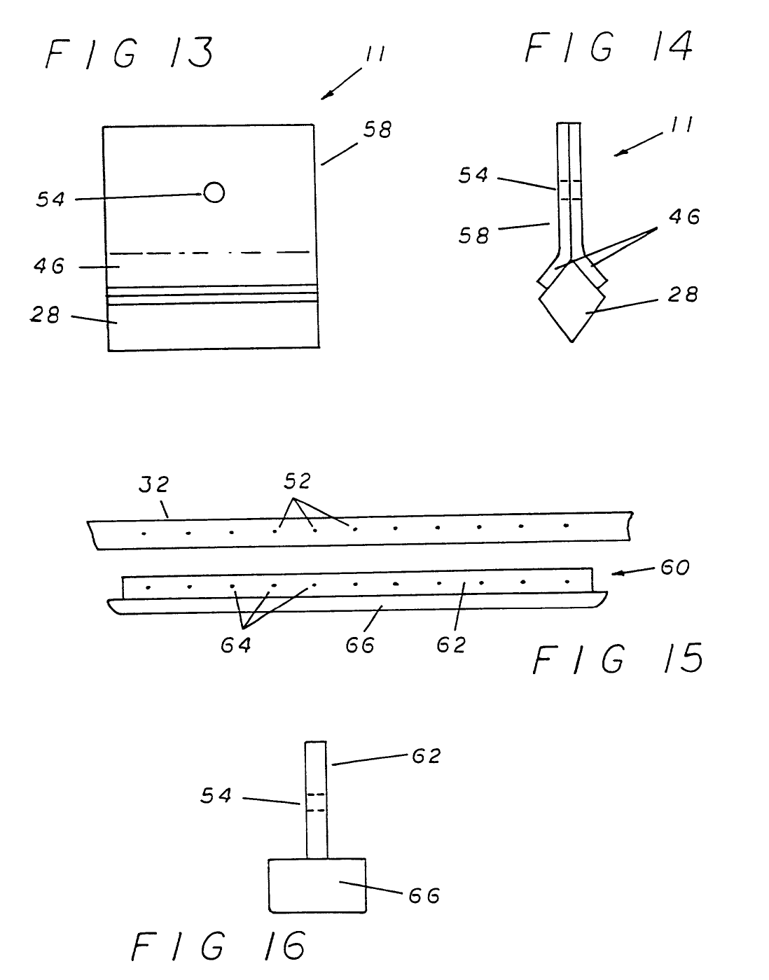

An alternative embodiment of the steering cleat member 11 of the present invention is illustrated in FIGS. 13 and 14. In this embodiment of the invention the carbide mount plate 48 of the previous embodiment is replaced by a two piece mount plate 58. The two piece mount plate 58 works in the same manner as the standard carbide mount plate 48, except that it has two relatively thin plates that have their lower most ends bent outward at an angle of approximately 45 degrees which forms the carbide mount tabs 46. Otherwise, the manner in which this embodiment functions and attaches to the 90 degree keel 32 is exactly the same as with the previous embodiment.

A further embodiment of the cleat portion of the present invention is illustrated in FIGS. 15 and 16. In this embodiment the individual steering cleat members 11 are replaced with a single UHMW plastic cleat 60. The UHMW plastic cleat 60 is primarily made up of the cleat edge 66, which is the replacement component for the carbide cleat 28 of the previous embodiment, and the UHMW plastic mount plate 62, which replaces the individual carbide mount plates 48 of the steering cleat members 11 described above. Additionally, the UHMW plastic mount plate 62 has a plurality of UHMW plastic plate pin holes 64 that correspond in location to the keel pin holes 52 located in the side of the 90 degree keel 32.

The UHMW plastic cleat 60 is formed at a length which corresponds to the length of the keel mount slot 56 located in the 90 degree keel 32. Thus, to install the UHMW plastic cleat 60 one simply places it into the keel mount slot 56 where it is held in place by the use of roll pins 50 in much the same fashion as described above. Finally, the UHMW plastic cleat 60 allows a user to add a further degree of steering impetus to a one piece molded snowmobile ski 10 in situations (such as organized racing) where the use of carbide or other metallic cleats is prohibited by rule or law.

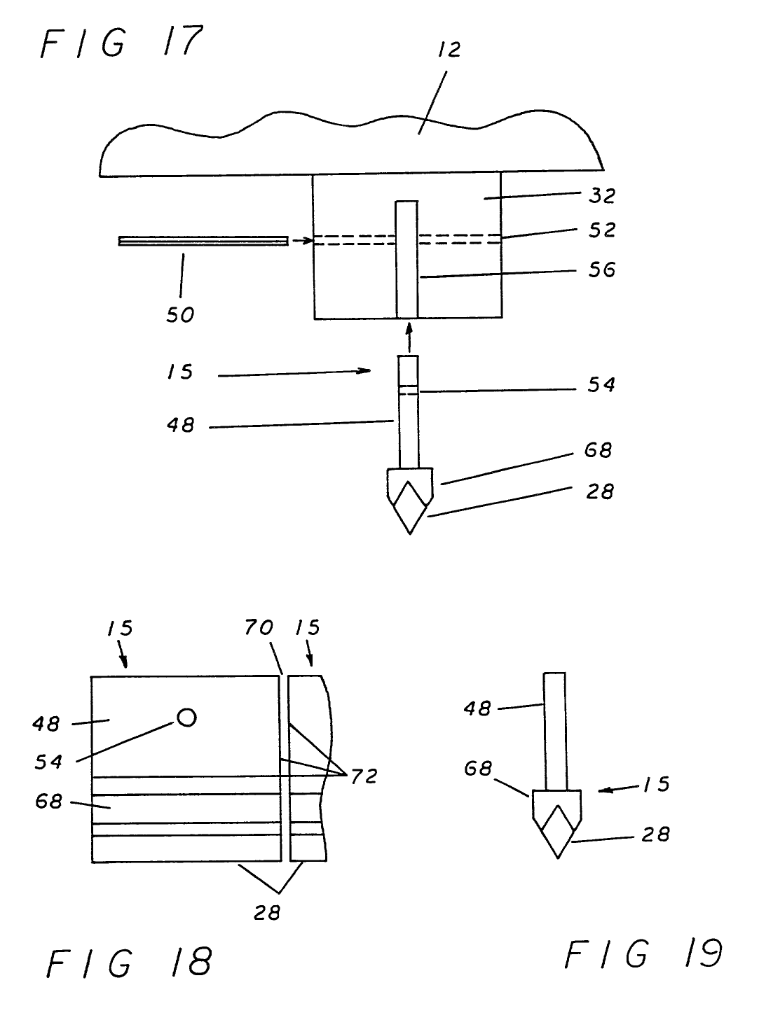

A further embodiment of the present invention is illustrated in FIGS. 17, 18, and 19 in which the flex indentation sides 42 of the previous embodiments of the invention are replaced with flat cleat sides 72 to create the flat-bottomed cleat 15 that is the subject of this embodiment. The initial difference with this embodiment of the invention is the manner in which the flat-bottomed cleat 15 is attached to the 90 degree keel 32 of the ski body 12. This attachment is accomplished again by fixing the carbide mount plate 48 within the keel mount slot 56 by passing the roll pin 50 through keel and plate pin holes, 52 and 54, located respectively in the body of the 90 degree keel 32 and the carbide mount plate 48. This positioning of the roll pin 50 effectively holds the flat-bottom cleat 15 in the proper position in the 90 degree keel 32.

The difference in the attachment comes in the fact that the flat-bottom cleat mount 68 portion of the flat-bottomed cleat 15 is equipped with a flat surface that butts up against the lower surface of the 90 degree keel 32 when fully installed. This flat surface provides the stability to the flat-bottomed cleat 15 when it is fixed within the 90 degree keel 32 for use and also has the advantage of removing the need for the use of the flexible cleat housing 44 that is required to attach other embodiments of the invention to the 90 degree keel 32.

The second difference between this embodiment of the present invention and the preceding is the manner in which space is provided between the individual flat-bottomed cleats 15 when mounted in the 90 degree keel 32. As previously stated, the flex indentations 42 of the carbide mount plate 48 of the previous embodiments are eliminated to leave the carbide mount plate 48 with flat cleat sides 72. Therefore, the space necessary to allow the present invention to flex with the ski body 12 is provided for by mounting the individual flat-bottomed cleats 15 with a inter-cleat gap 70. This inter-cleat gap 70 allows each of the flat-bottomed cleats 15 to move independently from its immediate neighbor without their flat cleat sides 72 interfering with one another. This design allows a plurality of individual flat-bottomed cleats 15 that are attached to the bottom of a 90 degree keel 32 to freely flex along with the entirety of the ski body 12 during the operation of a snowmobile in hilly or other varying terrain.

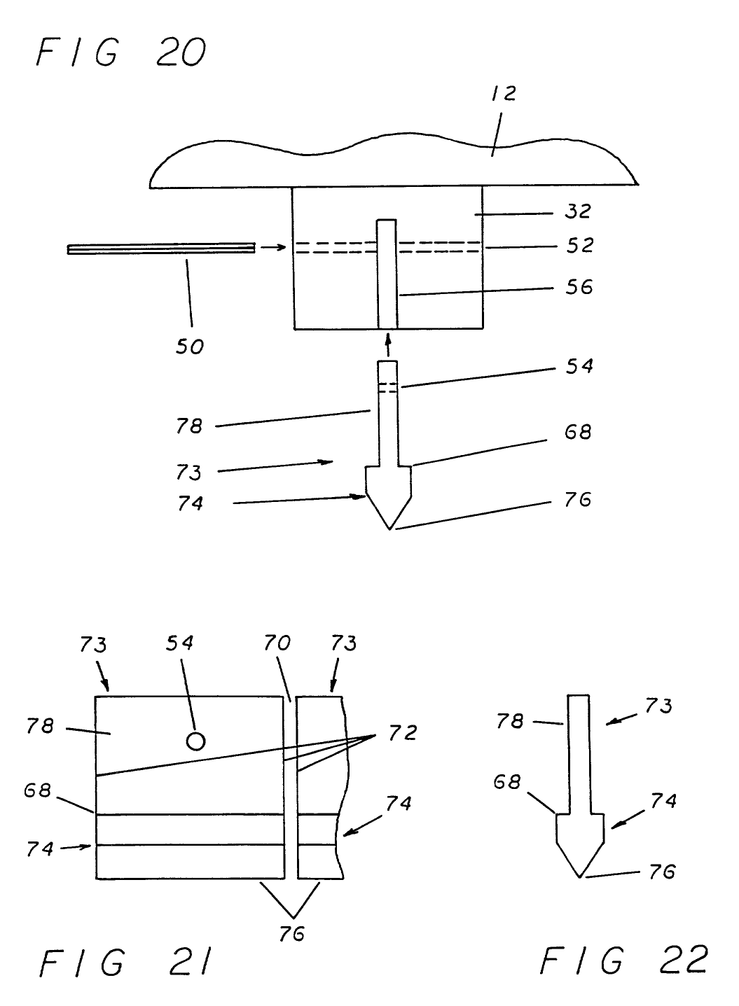

A still further embodiment of the present invention is illustrated in FIGS. 20, 21, and 22 in which the flat-bottomed cleat 15 of the previous embodiments is formed entirely from one solid piece of ADI. This embodiment of the present invention continues the improvements of the previous embodiment in that the ADI Cleat 73 is attached to the 90 degree keel 32 of the ski body 12 by fixing the ADI mount plate 78 within the keel mount slot 56 by passing the roll pin 50 through the keel and plate pin holes, 52 and 54. This positioning of the roll pin 50 holds the ADI cleat 73 in the proper position within the 90 degree keel 32. Additionally, the flat-bottomed cleat mount 68 portion of the present invention provides the structural stability to the ADI cleat 73 when in its proper position.

The ADI cleat also maintains the advantage of flat cleat sides 72 that are employed in the previous embodiment of the present invention. This method of construction requires that each individual ADI cleat 73 be mounted in a fashion which leaves an inter-cleat gap 70 between itself and its immediate neighbor This inter-cleat gap 70 allows each ADI cleat 73 to freely move with the flexing of the ski body 12 without their interfering with one another.

The primary difference with the ADI cleat 73 from the previously discussed embodiment is its method of construction and the material from which it is constructed. Firstly, the ADI cleat 73 is manufactured in such a manner so that the ADI cleat head 74, or that portion of the body of the invention containing the flat-bottomed cleat mount 68 and the ADI cleat edge 76, is made of, along with the ADI mount plate 78, one continuous piece of ADI material. This method of construction simplifies the manufacturing process by eliminating the additional assembly steps of fixing a carbide tip within a specially designed portion of the invention's head. This reduction of manufacturing time and materials significantly reduces the cost of producing the ADI cleat 73.

The other important distinction between the ADI cleat 73 and the previous embodiment is that it is entirely constructed of ADI (austempered ductile iron). This type of material was developed primarily for use in the manufacture of machine gears or other similar applications which require the use of a very hard and durable material. ADI is a heat treated iron that has the desirable characteristics of being relatively flexible, low in weight, low in price and has excellent strength and wear resistence. All these characteristics are combined in a material that is ten percent lighter than steel and compares favorably in the desired attributes with carburized or hardened steel. Therefore, the use of ADI in the production of the present invention provides a finished product that can be produced at a much lower cost than other methods of construction and which also provides the desirable characteristics of strength and durability that are obtained in the more expensive method of design and construction of the previous embodiments.

Although the present invention has been described in considerable detail with reference to certain preferred versions thereof, other versions are possible. For example, the disclosed invention could be used on any vehicle having skis. Therefore, the spirit and scope of the appended claims should not be limited to the description of the preferred versions contained herein.

What is claimed is:

1. A flexible runner assembly for use on a flexible vehicle ski, said ski having a base section with an upper and lower side for receiving said flexible runner assembly, with said flexible runner assembly comprising:
a plurality of runner cleats having a flat plate like mounting section said mounting section having a left and right side, a front and back side, and a bottom edge;
a cleat mount section further attached to said bottom edge of said mounting section;
a cleat section attached to said cleat mount section said cleat section being parallel to the bottom edge of said mounting section; and
said runner cleats being mounted front side to back side of each cleat along the lower side of said ski so as to form a series of runner cleats having breaks between each cleat so as to allow said ski to flex.

2. The flexible runner assembly as in claim 1 wherein said mounting plate further defines a fastener receiving section.

3. The flexible runner assembly as in claim 2 further comprising a plurality of fasteners for mounting said runner cleats to said ski by passing through said fastener receiving section perpendicular to said mounting section.

4. The flexible runner assembly as in claim 3 wherein said cleat mount section defines a flat surface for contact with the lower side of said ski.

5. The flexible runner assembly as in claim 4 wherein said cleat section is made of carbide.

6. The flexible runner assembly as in claim 4 wherein said runner assembly is formed as one piece of an austempered ductile iron.

7. A flexible vehicle ski assembly said ski assembly comprising:
a ski having a base section with an upper and lower side and a curved front portion;
an elongate keel section protruding from the lower side of said skis base section;
a plurality of runner cleats having a flat plate like mounting section said mounting section having a left and right side, a front and back side, and a bottom edge;
an elongate slot section defined by said elongate keel section for receiving said plurality of runner cleats mounting sections;
a cleat mount section further attached to said bottom edge of said mounting section;
a cleat section attached to said cleat mount section said cleat section being parallel to the bottom edge of said mounting section; and
said runner cleats being mounted front side to back side of each cleat along the keel of said ski so as to form a series of runner cleats having breaks between each cleat so as to allow said ski to flex with out hindrance from said runner cleats.

8. A flexible vehicle ski assembly as in claim 7 wherein said mounting plate further defines a fastener receiving section.

9. A flexible vehicle ski assembly as in claim 8 further comprising a plurality of fasteners for mounting said runner cleats to said ski by passing through keel and said fastener receiving section perpendicular to said keel.

10. A flexible vehicle ski assembly as in claim 9 wherein said cleat mount section defines a flat surface for contact with the lower side of said ski.

11. A flexible vehicle ski assembly as in claim 10 wherein said cleat section is made of carbide.

12. A flexible vehicle ski assembly as in claim 11 wherein said runner assembly is formed as one piece from an austempered ductile iron.

13. A vehicle ski cleat said cleat comprising;
a flat plate section having a top and bottom edge said flat plate section further defining a fastener receiving section;
a lower mounting section, fixedly attached to said bottom edge of said flat plate section, for receiving an inset said lower mounting section having a right and left side; and
an inset fixedly mounted to said right and left side of said mounting section.

14. A vehicle ski cleat as in claim 13 wherein said inset is a elongate substantially rectangular piece of carbide mounted so that a corner of said inset is opposite of said plate.

15. A vehicle ski cleat as in claim 14 wherein said lower mounting section a flat surface adjacent to said flat plate section.

16. A vehicle ski cleat as in claim 15 wherein said runner assembly is formed as one piece from an austempered ductile iron.
